(19) United States
(12) Patent Application Publication
(10) Pub. No.: US 2008/0289046 A1
(43) Pub. Date: Nov. 20, 2008

(54) Method and device for the prevention of piracy, copying and unauthorized execution of computer-readable media

(76) Inventor: Thomas Michael Fryer, Lancaster, CA (US)

Correspondence Address: Thomas Fryer, Suite 103, 41319 12th St. W., Palmdale, CA, 93551, US

(21) Appl. No.: 12/154,160

(22) Filed: May 19, 2008

Related U.S. Application Data
(60) Provisional application No. 60/930,797, filed on May 17, 2007.

(51) Int. Cl. G06F 1/00

(52) U.S. Cl. 726/26

(57) ABSTRACT

Piracy is a growing concern for digital content and intellectual property holders. Prior art technology and Digital Rights Management (DRM) have failed to provide content holders with an effective solution. Too often, DRM is compromised within days of release offering little or no protection to content owners. This invention offers a unique process and/or method for protecting computer-readable media that is fast, efficient, and economical to implement, and can be implemented with all types of content. This invention provides the means to prevent piracy, copying, and unauthorized use of content on all computer-readable media (physical or memory-based).

### CROSS-REFERENCE TO RELATED APPLICATIONS

This application claims the benefit of U.S. Provisional Patent Application No. 60/930,797, filed on May 17, 2007, which is incorporated herein by reference.

### BACKGROUND

The present invention relates to methods of preventing digital content piracy such as the unauthorized copying of digital content or the unauthorized execution of computer-readable media and the like.

Conventional protection of computer-readable media from piracy, copying, or unauthorized use of the software code suffer from the following flaws.

The growing sophistication of tools and utilities freely available to anyone with an Internet connection makes it a fairly easy process to ‘spoof’ or ‘foil’ current verification mechanisms. Given the fact that nearly all such protection mechanisms use a sophisticated mathematical formula, algorithm, or a derivation/combination of the two—with enough processing power, the right skills and tools, any security mechanism that utilizes these methods or derivations of these methods and processes can be sufficiently re-created and fooled.

Duplication refers to the copying of the program in entirety or pieces of the program. Convention anti-copying requirements utilize mechanisms like a ‘key’ or the requirement that the original medium is accessible. Generally, these mechanisms are based upon specific time intervals and/or usage conditions. Given that these conditions are predicated upon specific sequences, they can be fooled into allowing the ability to make unauthorized copies of content generally protected by intellectual property (e.g., copyrighted material).

Additionally any safeguard mechanisms employed to prevent unauthorized use or access of the content can be similarly foiled into believing that either the conditions have not been met or the neutralizing mechanism has been neutered. In either case the content has been compromised.

Another major problem is that the end-user, or rather the target device, has unlimited access to the program. Given this necessity of current computer architecture it is then possible to access the code in memory to analyze, modify, or otherwise alter the parameters of the computer code. This vulnerability makes it possible to utilize various tools, kits, and exploits to circumvent protection mechanisms and compromise the intellectual property holders rights.

Another problem is the ability to clone or spoof individualization mechanisms. An individualization mechanism is supposed to ensure that the software associated with the target device cannot be moved, duplicated, or tampered with. Given the sophistication of software and virtualization techniques it is possible to ‘clone’ the environmental parameters of the individualized environment and execute this environment in such a way that the individualization mechanism cannot detect any changes to its actual environment. Under these conditions, the program will be executed as if it were in its original environment, all the conditions of which have been re-created.

Additionally, various standard and non-standard encryption methods are utilized to prevent piracy, copying, and/or unauthorized use of software, video, or other embedded information on various media. However, the ‘key’ is placed on the medium or derived from the medium; eventually the key will be cracked and the protection will no longer be valid, allowing the content to be distributed in violation of the intellectual property rights of the owner of the content.

Piracy is a major problem faced by owners of digital content such as software, games, films, music, etc. Every year, billions of dollars are lost by the owners of digital content and to date, there exists no method that can prevent piracy or at least prevent piracy for a long enough time period.

What is needed is a new method of preventing piracy which does not exhibit the above-mentioned shortcomings and is effective in preventing the unauthorized copying of digital content.

### SUMMARY

It is an object of this invention to provide a method of preventing piracy, unauthorized copying of program and/or key components of said program, and unauthorized execution of said program.

Generally, this invention provides a method of preventing piracy by ‘bonding’ the content to the medium. In this case the medium is the target device which could be a computer, software, Compact Disc-Read Only Memory (CD-ROM), Digital Versatile Disc-Read Only Memory (DVD-ROM), Universal Serial Bus Drive, or any other computer-readable media. Furthermore, in one aspect, this invention provides a method of preventing piracy by bonding the content of the computer-readable medium and/or computer-readable medium itself, to the target device, usually a computing device.

This invention utilizes a new approach to obtain a unique serialization of the target device by obtaining the machine code of selected devices as a seed which is then subjected to a modulo operation and then hashed to a random number of digits, as determined by the implementation.

Verification is accomplished by linking the unique serialization with a serial number that was also generated. The serial numbers are generated with certain bits within the serial number that will actually determine the number of bytes used (or length) in the response sequence.

Intra-system workings of this invention are kept secure through the use of a standard and/or non-standard in-memory hash. The encryption is accomplished in real-time before the message is sent. Likewise, the decryption is done in real-time after the message is received. This portion takes place at a low level in the target device (usually a computing device) to prevent monitoring of the software execution and/or operations in memory.

### BRIEF DESCRIPTION OF THE DRAWINGS

FIG. 1 is an illustration of the EXE wrapping mechanism;

FIG. 2 shows two modules of code before being encoded with a standard and/or non-standard cryptographic hash;

FIG. 3 shows two modules with a cryptographic hash encoded into each of them;

FIG. 4 illustrates two completed, fully encoded modules within the protected system;

FIG. 5 is an illustration of the components utilized to obtain a unique serialization code.

### DETAILED DESCRIPTION

In a preferred embodiment of this invention, a unique serialization code is required to ‘bond’ the program to the medium or the target device. Two methods are preferably used to obtain a unique serialization:

1) In the case of Digital Versatile Disc-Read Only Memory (DVD-ROM) and Blu-Ray ROM the invention preferably utilizes the Burst Cutting Area (BCA) or Narrow Burst Cutting Area (NBCA)—U.S. Pat. No. 6,608,804 B2;

2) In all other cases this invention utilizes five major components found within virtually all target devices to generate a random, but unique serialization code that may be linked to a separate, but randomized serial number that could be used to ‘unlock’ the protected content. It is to be noted that the cases of DVD-ROMs and Blu-Ray ROMs one of one could also use these 5 major components in order to obtain a unique serialization.

As stated above, the unique serialization of the target device is preferably obtained by using five major components. The five components are the Central Processing Unit (CPU), Network Interface Card (NIC), Motherboard, Video Display Unit, and the first non-removable drive. In embodiments where a component is not present, then it is not used or a null value is used in its place. While in a preferred embodiment these five components are preferably utilized to develop the unique serialization, this invention is not limited to these components. In another preferred embodiment of this invention different components are used for different target devices.

In one embodiment, a hash is taken from the CPU and the NIC and is used to determine the components and the number of digits that will be used for the final hash code which will also be used to determine which bit field will be used in the randomly generated serial number for the authentication response code.

The resultant hash of the CPU and the NIC is subjected to a modulus operation (MOD 3) which gives the following three possibilities (where A through D represent each of the five components):

1.0=A+B+C

2.1=C+D+A

3.2=A+B+C+D+E

The resulting numbers of digits to then hash are calculated from the same MOD 3 result as follows:

1.0=16+2(18 digits)

2.1=16+4(20 digits)

3.2=16+6(22 digits)

The final hash is then obtained by pushing the results of the MOD 3 hash of the CPU and NIC through the hasher with matching selection of the number of digits to hash. The result is a unique machine code number for the target device. One of the preferred embodiments of this operation is to use a randomized algorithm in selecting grouping of components along with a random selection of additional hashing bits to use in the generation of the unique machine code. The serial number is also preferably generated at the same time. Serial numbers can be generated in batches with runs 1 to n in size. Since the level of randomness of the serial number is dependent upon obtaining a sample number from the CPU and then applying a MOD 3 hash, additional randomized serial numbers can be generated. In a preferred embodiment, the CPU hash is the seed used to generate the serial numbers.

An additional method of unique serialization for the embodiments including DVD-ROMs and Blu-Ray ROMs is the use of the BCA or NBCA. The BCA or NBCA is a special area of the DVD-ROM or Blu-Ray ROM that can be read by current DVD or Blu-Ray readers. It is important to note that while the BCA or NBCA is used, in the present invention, it is preferably not used to hold a unique serial number or cryptographic key; rather the BCA (or NBCA) code is part of the overall program providing protection to content.

To prevent spoofing of the reader, the BCA or NBCA is preferably encoded with a hash of the contents of the BCA (or NBCA). Therefore if the contents of the BCA (or NBCA) are not present then the reader will not return the correct hash. However, the reader must return the correct hash for the system to function properly. Because this process and/or program utilize in-memory encryption (described below) to prevent reading of the hash it makes guessing or spoofing the value of the hash virtually impossible. In a preferred embodiment of this invention a different hash for each DVD-ROM or Blu-Ray ROM is used.

The contents of the DVD-ROM or Blu-Ray ROM are then encrypted, using standard and/or non-standard encryption techniques. The Autorun file will then check the BCA (or NBCA) and if the correct hash is returned, the contents of the DVD-ROM or Blu-Ray ROM will be accessible. A Mt. Fujitsu standardized reader is not required to be able to read the BCA (or NBCA) from the DVD-ROM or Blue Ray ROM.

The In-memory hash uses encrypted messaging to communicate between modules. The actual message to another module is encrypted, using standard and/or non-standard encryption methods, before it is sent to the target module. The target module then decrypts and processes the message, and likewise sends an encrypted message back to the calling module with the response. Using this type of methodology, it doesn't matter if anyone can trace the message pathways; they would also have to break the encryption in order to translate the message.

The premise of the in-memory hash is the fact that messages are being processed while the modules are running in computer memory, sending encrypted messages between them. All of the modules involved in the in-memory hash are compiled at encoding time with their encryption keys. Because this is set at encoding time, no set of in-memory hash modules will use the same key.

A function within every module encoded encodes and decodes every message to be sent between modules. All modules encoded also know how to call and send messages to other modules through the encryption/decryption module. Each message to be sent is packaged in a custom XML-like object that can be serialized and de-serialized to a format that is easily encrypted and decrypted.

This can be applied to modules spanning a local system, between computer and removable media, and/or across network/Internet connections. The message is encoded and decoded from within the associated modules, so there is no additional encryption/decryption required as it crosses communication barriers.

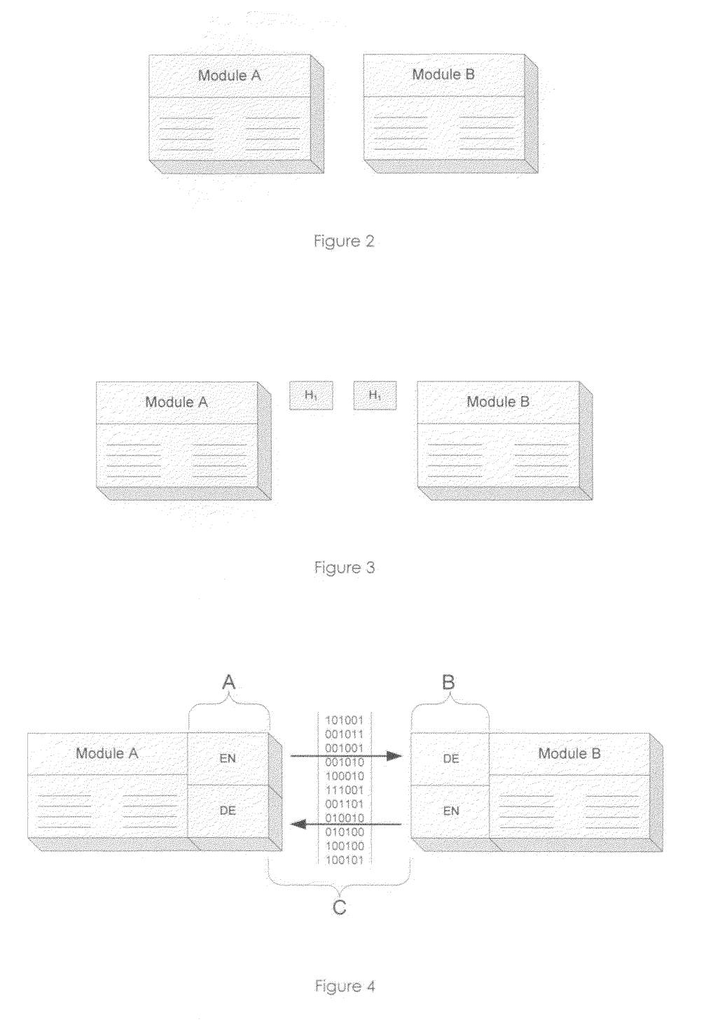

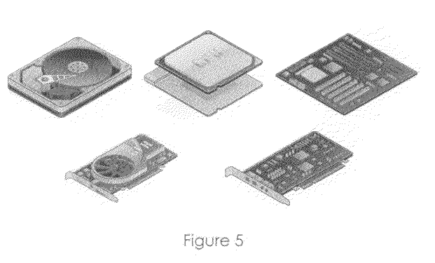

Referencing FIG. 2, module A and module B are going to be encoded with the cryptographic hash (H₁). The cryptographic hash is a standard hash taken from the unique serialization. This standard hash can be changed as needed for each customer, or each time the encoding application is built. It must be compiled in to limit the areas where code can be watched (FIG. 4, Area C in the diagram). While this illustration only depicts two modules, this method and/or program is not limited in number or scope.

FIG. 3 illustrates how the same cryptographic hash is compiled into each module. While this illustration only shows two modules it must be understood that all modules (regardless of the number, size, or scope) within the protected system are compiled at the time of encoding.

FIG. 4 illustrates the completed, fully encoded modules within the protected system. Areas A and B are functionally equivalent, and all of the modules are compiled with the cryptographic hash in the same manner utilizing standard and/or non-standard encryption techniques. Showing the opposite on each end allows for the simple illustration of the process. EN stands for Encrypting and DE stands for Decrypting. The area under the label ‘Module’ for both modules shows the final compiled module has a standard code package which sends and receives messages. A message can be a function call, or the return from a function call. The code within the module itself simply sends and receives messages like normal. However, the encrypting/decrypting component of the module will encrypt each outbound message with the cryptographic hash compiled in at the time of encoding. The area C illustrates an observer attempting to watch the modules communicating in memory. The stream of bits (1's and 0's) illustrates encrypted data that an observer cannot see.

The encoding application preferably contains all necessary tools and packages to perform the compilation. The main premise of this entire system is to “black box” the whole operation, requiring a minimum of effort and knowledge from the end user and content provider.

One of the ways used to break a system is by watching the parts of that system in action. By encrypting the outbound messages of a function call or return, an observer cannot simply decipher the bits that fly by. There are no simple Boolean return values, or objects in the data. Also, the same message sent twice in a row will appear different after encrypting. This prevents the observer from simply copying a previously sent message and sending it again, thereby protecting the content.

A unique prefix is placed at the beginning of the EXE file that will prevent execution of the EXE file until the EXE file has been authorized to execute. This is done at encoding time and is unique to each encoding session.

Additionally, an encrypted hash (utilizing standard and/or non-standard encryption techniques) is tagged onto the EXE file. The hash is used to verify that the EXE file has not been tampered.

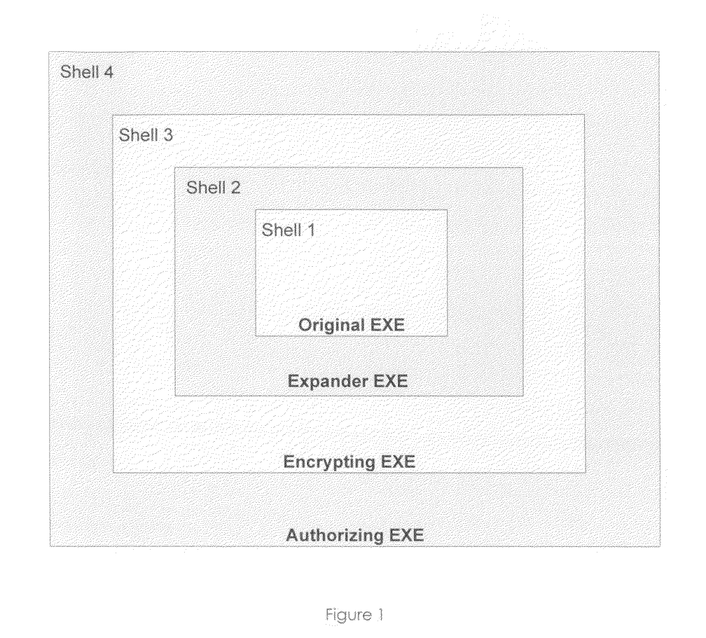

FIG. 1 illustrates that the EXE file is actually 4 independent, yet integrated shells.
Shell 1: Original EXE. The innermost shell. This contains the original executable provided by the customer or content provider.
Shell 2: Expander exe. This executable is responsible for expanding the original exe into a DLL in memory. All communications to and from this DLL are processed just like the normal original exe. It is expanded into memory so it is much more difficult to take an image and try to copy it and use it. It is deleted from memory upon close of the application.
Shell 3: Encryption/Decryption EXE. The third shell is the primary encryption exe. This is responsible for keeping everything encrypted up to the point it's expanded into memory.
Shell 4: Authorization EXE. The fourth shell is responsible for ensuring the system is authorized to decrypt, expand, and execute. If the system has not been previously authorized, it attempts to authorize the executable. If authorization has occurred, permission is given to the shell 3 to decrypt and begin execution.

The claims appended hereto are meant to cover modifications and changes within the scope and spirit of the present invention.

1. A method of preventing the unauthorized copying of digital content by computing a unique serialization code, the method comprising the steps of:
a) taking a first hash from a CPU or an NIC;
b) using the first hash to determine a set of components and number of digits to be used in a final hash;
c) using the final hash to determine a bit field to be used in the generation of a randomly generated serial number;
Wherein the unique serialization code is computed, thereby preventing the unlawful copying of digital content.

2. The method of claim 1 wherein the first hash is subjected to a modulus operation.

3. The method of claim 2, wherein numbers of digits resulting from the modulus operation to then hash, are calculated from the modulus operation.
